(19) United States
(12) Patent Application Publication
(10) Pub. No.: US 2007/0286923 A1
(43) Pub. Date: Dec. 13, 2007

(54) Piston and valve stem assembly for a hot runner

(75) Inventor: Edward Joseph Jenko, Essex, VT (US)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, US

(73) Assignee: Husky Injection Molding Systems Ltd.

(21) Appl. No.: 11/449,093

(22) Filed: Jun. 8, 2006

(51) Int. Cl. B29C 45/23; B29C 45/74

(52) U.S. Cl. 425/549; 425/564

(57) ABSTRACT

A unified monolithic piston/valve stem structure for a gated-valve type injection molding hot runner. The piston/valve stem structure includes a piston and a valve stem that are joined to each other in a non-threaded manner without the need for any preformed securing devices formed separately from the piston and valve stem.

### FIELD OF THE INVENTION

The present invention generally relates to the field of injection molding and more particularly to a unified monolithic piston/valve stem structure for a hot runner.

### BACKGROUND OF THE INVENTION

Each injection-molding system for making molded items typically includes, among other things, an injection molding machine, mold plates, and a hot runner containing a heated manifold that distributes molten material to one or more injection nozzles. Each injection nozzle may correspond to one or more mold cavities within a pair of mold plates, whereby the molten material is injected into the mold cavity(ies) through a gate located proximate one end of the nozzle. During an injection cycle, the orifice may be selectably opened and closed to, respectively, start and stop the flow of the molten material to the mold cavity(ies).

Generally, there are two types of gating arrangements used in hot runner systems that are known to those having ordinary skill in the art. The first type of gating arrangement is a thermal gate. In a thermal gate arrangement, molten plastic is injected from the injection molding machine to the hot runner and forced through the hot runner system under pressure and injected through an injection nozzle into a cavity of a mold via the mold opening or gate. When the mold cavity is filled, the pressure to the hot runner system is terminated. The molten plastic remaining in the hot runner system is maintained in a molten or liquid state due to the various heating elements in the hot runner system. However, the plastic in the gate area solidifies because the surrounding area is not sufficiently heated to maintain the liquid or molten state. As a result, this solidification acts as a plug in the gate area precluding molten plastic from leaking from the nozzle of the hot runner system. During the next injection cycle, molten plastic is forced into the mold cavity at a pressure and temperature sufficient to force the plastic plug that formed at the gate area into the mold cavity. One of the problems with thermal gates is the difficulty creating the solidification or plug in the gate area. Another problem with thermal gates is improper gate vestiges.

Because of the problems and disadvantages with the thermal gates, a second type of gating arrangement is used. Mechanical gates, such as valve gates, are often utilized in place of thermal gates. In a valve gate arrangement, a valve stem extends in, and approximately parallel or coaxial with a longitudinal axis of, the flow channel of the injection nozzle and the flow channel or internal passage of the manifold or valve bushing. A piston/cylinder actuator actuates or moves the valve stem forward and backward in the axial direction into an open and closed position, respectively. While a variety of actuators have been developed for moving the valve stem, at present the most popular type of actuator is a double-acting pneumatic actuator that uses a piston and cylinder arrangement and pressurized air to move the valve stem. In these actuators, the valve stem is secured to the piston, and the pressurized air is controllably supplied to one side or other of the piston within the cylinder so as to move the piston and valve stem in the respective direction. When the pressure to the hot runner system is terminated, the piston moves the valve stem axially into the closed position. The tip of the valve stem plugs the opening in the gate area of the mold cavity. In the closed position, the valve stem precludes molten plastic from entering the mold cavity. During the next injection cycle, the cylinder moves the valve stem up or into the open position, and pressure is applied to the hot runner system to force molten plastic through the flow channels. This allows molten plastic to be forced through the injection nozzle of the hot runner system into the mold cavity via the mold opening or gate.

Most conventional valve stem/actuator arrangements typically include a solid (as opposed to hollow) valve stem that is concentrically centered and coaxial within a flow passageway that supplies molten material to the injection nozzle. The gating action of such a valve stem is accomplished by moving the stem into and out of the gate proximate the injection nozzle so as to alternatingly block and unblock the molten material from exiting the gate. In this type of arrangement, the valve stem is typically secured to the piston using a variety of preformed securing devices.

For example, U.S. Patent Application Publication No. 2003/0143298 to Blais shows a headed valve stem in which the stem is secured to the piston by retaining the head of the stem within a mating seat using a set screw. Each of U.S. Pat. No. 6,555,044 to Jenko, U.S. Pat. No. 6,228,309 to Jones et al. and U.S. Pat. No. 5,334,010 to Teng, also show such a set-screw arrangement for securing the valve stem to the piston. Another popular design for securing a headed valve stem to a piston is to capture the head of the stem in a corresponding seat within the piston using a retaining plate. In turn, the retaining plate is secured to the piston, typically using threaded fasteners. This retaining plate arrangement is shown, e.g., in U.S. Pat. Nos. 6,214,275 to Catoen et al., U.S. Pat. No. 5,518,393 to Gessner, U.S. Pat. No. 5,200,207 to Akselrud et al., U.S. Pat. No. 5,112,212 to Akselrud et al. and U.S. Pat. No. 5,071,340 to LaBianca. A shortcoming of these designs is their complexity due to the number of components needed to secure the valve stem to the piston. In addition, these designs require a relatively large amount of machining to create the headed valve stem and corresponding seat in the piston, as well as the threaded parts. Further, these designs require a significant amount of assembly time to assemble the previously described machined parts.

Other types of connections of solid valve stems to pistons have also been used and/or proposed. For example, U.S. Patent Application Publication No. 2003/0180409 to Kazmer et al. shows a valve stem secured to the piston by a pin that is engaged with the piston and extends through a slot in the stem in a direction transverse to the longitudinal axis of the stem. The Kazmer et al. publication also shows a valve stem that is threaded at its piston end and threadedly engaged with the piston. The pin-type Kazmer et al. piston/valve stem assembly has the drawback of relatively complex, expensive construction. The threaded-type Kazmer et al. piston/valve stem assembly has the shortcoming that the stem could work loose during use if the threads are not properly tightened. Moreover, the piston and valve stem must be machined, tapped and died so as to create the mating threads.

In addition to the solid valve stems arrangements just discussed, U.S. Pat. No. 5,975,127 to Dray discloses a shut-off valve that includes a piston containing a central passageway for conducting a first molten material therethrough. The piston has a “downstream” portion that slidingly engages a valve body as the piston is moved. The downstream portion of the piston is closed, except for side opening apertures that are alternatingly blocked and unblocked by the valve body upon movement of the piston so as to block and allow flow of the first molten material through the valve. In another embodiment, the distal end of the downstream portion alternatingly blocks and unblocks lateral passageways in the valve body that are oriented transverse to the central passageway of the piston so as to block and allow flow of a second molten material in an alternating fashion with the allowing and blocking of the flow of the first molten material flowing through the central passageway of the piston. Drawbacks of this design are that it is fundamentally different from proven valve-stem-gated injection nozzle designs and requires parts that are relatively complex to manufacture.

### SUMMARY OF THE INVENTION

In one aspect, the present invention is directed to a unified monolithic piston and valve stem structure for a hot runner that includes a drop comprising an injection nozzle having a longitudinal central axis and an actuator cylinder spaced from the injection nozzle along the longitudinal central axis. The unified monolithic piston and valve stem structure comprises a piston sized to operatively engage the actuator cylinder. An elongate valve stem is configured for controlling flow of a material through the drop when the unified piston and valve stem structure is operatively engaged with the hot runner. The elongate valve stem includes a piston-engaging end non-threadedly secured to the piston without any pre-formed securing devices.

In another aspect, the present invention is directed to an assembly for a hot runner. The assembly comprises an injection nozzle having a longitudinal central axis. An actuator cylinder is spaced from the injection nozzle along the longitudinal central axis. A unified monolithic piston and valve stem structure comprises a piston operatively engaging the actuator cylinder. An elongate valve stem is configured for controlling flow of a material through the injection nozzle and includes a piston-engaging end non-threadedly secured to the piston without any preformed securing devices.

In a further aspect, the present invention is directed to a hot runner for injection molding plastic parts. The hot runner comprises a manifold plate and at least one drop extending through the manifold plate. The at least one drop comprises: 1) an injection nozzle having a longitudinal central axis; 2) an actuator cylinder spaced from the injection nozzle along the longitudinal central axis; and 3) a unified monolithic piston and valve stem structure. The unified monolithic piston and valve stem structure comprises a piston operatively engaging the actuator cylinder. An elongate valve stem is configured for controlling flow of a material through the injection nozzle and includes a piston-engaging end non-threadedly secured to the piston without any preformed securing devices.

In yet another aspect, the present invention is directed to a method of making a unified monolithic piston and valve stem structure for a hot runner comprising a drop that includes a valve actuator cylinder having an inside diameter The method comprises providing a valve stem having a configuration selected to control flow of a material from the drop. A piston having an outside diameter selected as a function of the inside diameter of the valve actuator cylinder is provided. The valve stem and the piston are non-threadedly unified with one another without using any preformed securing devices.

### BRIEF DESCRIPTION OF THE DRAWINGS

For the purpose of illustrating the invention, the drawings show a form of the invention that is presently preferred. However, it should be understood that the present invention is not limited to the precise arrangements and instrumentalities shown in the drawings, wherein:

FIG. 1 is a partial cross-sectional view of a hot runner made in accordance with the present invention;

FIG. 2 is an enlarged partial cross-sectional view of a unified monolithic piston/valve stem structure of the present invention in which the valve stem is secured to the piston by energy beam welding;

FIG. 3 is an enlarged partial cross-sectional view of a unified monolithic piston/valve stem structure of the present invention in which the valve stem is secured to the piston by filler metal welding;

FIG. 4 is an enlarged partial cross-sectional view of a unified monolithic piston/valve stem structure of the present invention in which the valve stem is secured to the piston by stir welding;

FIG. 5 is an enlarged partial cross-sectional view of a unified monolithic piston/valve stem structure of the present invention in which the valve stem is secured to the piston by integral molding;

FIG. 6 is an enlarged partial cross-sectional view of a unified monolithic piston/valve stem structure of the present invention in which the valve stem is secured to the piston by shrink fit;

FIG. 7A is an elevational view of a unified monolithic piston/valve stem structure of the present invention in which the valve stem is secured to the piston by brazing performed in connection with a metal infiltration technique; FIG. 7B is an enlarged cross-sectional view of the unified monolithic piston/valve stem structure of FIG. 7A showing the brazed/infiltrated connection between the valve stem and piston; and

FIG. 8 is a partial cross-sectional view of a unified monolithic piston/valve stem structure in which the piston and valve stem are formed seamlessly with one another.

### DETAILED DESCRIPTION

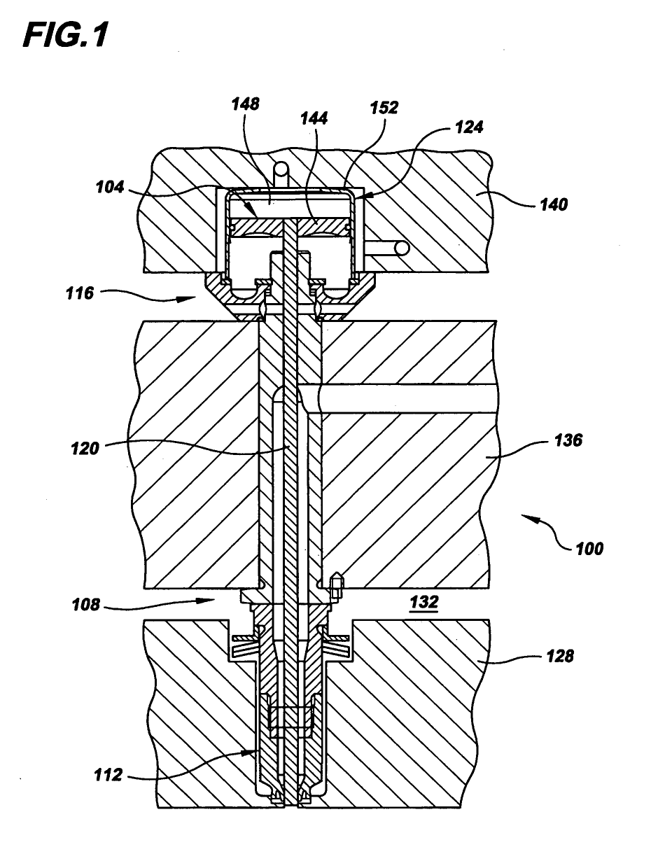

Referring now to the drawings, FIG. 1 illustrates a hot runner 100 made in accordance with the present disclosure. The hot runner 100 includes a piston/valve stem structure 104 that allow the hot runner 100 to be made in a cost-effective manner and with fewer and less-complex manufacturing steps than similar conventional hot runners not having the piston/valve stem structure 104 of the present disclosure. The piston/valve stem structure 104 and other piston/valve stems structure 200, 300, 400, 500, 600, 700, 800 made in accordance with the present disclosure are described below in detail.

The hot runner 100 may include one or more “drops” 108 for injecting molten plastic (not shown) into one or more mold cavities (not shown) in a known manner. Each drop 108 generally includes an injection nozzle 112 that is gated by a corresponding valve gate/actuator assembly 116 that includes a valve stem 120 and an actuator 124 for moving the valve stem 120 as needed to suit a particular molding situation. The hot runner 100 may be of virtually any design that includes the valve gate/actuator assembly 116 or similar assembly that includes the piston/valve stem structure 104 or other piston/valve stem structure 200, 300, 400, 500, 600, 700, 800 made in accordance with the present disclosure. That said, for the sake of illustration, and not limitation, the hot runner 100 of FIG. 1 is of the manifold plate/backing plate type that includes a manifold plate 128 having one or more manifold cavities 132 that contains at least one manifold 136 for distributing molten plastic from an inlet or another manifold to each drop 108 in a manner known in the art. A manifold 136 is housed within the manifold cavity 132 by a backing plate 140 and a manifold plate 128.

An actuator 124 may be of a pneumatic or hydraulic type in which a gas, liquid or other fluid is controllably pressurized so as to cause the valve stem 120 to move between an open position and a closed position in order to control the flow of molten plastic out of the injection nozzle 112. In this connection, the piston/valve stem structure 104 includes a piston 144 against which the pressurized fluid acts in causing the valve stem 120 to move. The piston 144 is sealingly engaged within a cylinder cavity 148, which in the example shown is generally defined by a relatively thin-walled cylinder structure 152. Of course, in alternative designs, the cylinder cavity 148 may be formed in another manner, such as a bore in a more massive block or plate.

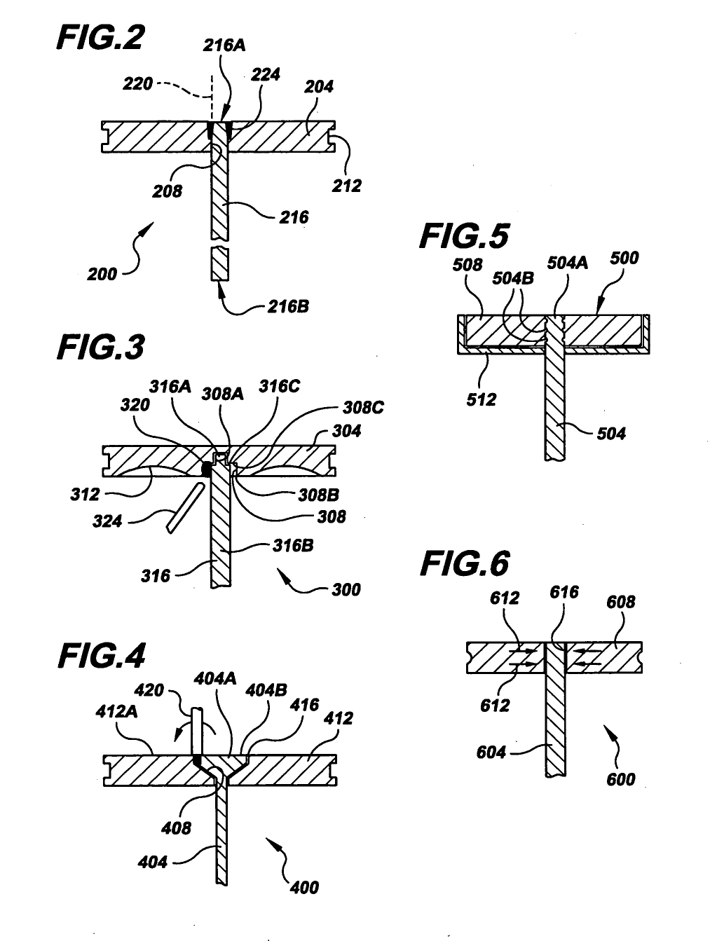

In the preferred embodiment, the piston/valve stem structure 104 has a “unified monolithic” design, which allows the piston/valve structure 104 to take a very simplistic form and be made in a highly cost-effective manner. By “unified monolithic” it is meant that the valve stem 120 is secured to the piston 144 without any sort of preformed securing devices, i.e., devices that are formed separately and distinctly from the piston and valve stem and subsequently fastened to, inserted into or otherwise engaged with the piston 144 or the valve stem 120, or both. Examples of preformed securing devices include fastening means, e.g., threaded fasteners or retaining pins, collets, plates, etc., that are formed separately and distinctly from the valve stem 120 and that must be attached, inserted or otherwise engaged with the piston/valve stem structure 104 to effect securement of the valve stem 120 to the piston 144. The term “uniform monolithic” also connotes a very secure and permanent connection, unlike the threaded connection of the Kazmer et al. publication discussed in the Background section above in which the valve stem can be disconnected simply by unscrewing it from the piston. Examples of such unified monolithic designs are discussed below in connection with FIGS. 2-8 in the context of corresponding respective the unified monolithic piston/valve stem structures 200, 300, 400, 500, 600, 700, 800.

FIG. 2 illustrates a unified monolithic piston/valve stem structure 200 of the present disclosure that includes a very simple disk-shaped metal piston 204 that includes a central opening 208 and a peripheral seal seat 212 for receiving an O-ring (not shown) or other seal. A metal valve stem 216 has a piston-engaging end 216A engaged within the central opening 208 of the piston 204 and a gate end 216B located the proper distance from the piston 204 for operatively engaging the injection nozzle, e.g., injection nozzle 112, with which the unified monolithic piston/valve stem structure 200 is designed to operate. The valve stem 216 may have a maximum outside diameter that is substantially the same as the inside diameter of the central opening 208.

Making the maximum outside diameter of the valve stem 216 the same or nearly the same as the inside diameter of the central opening 208 can have at least two benefits. A first benefit is that with this configuration, the valve stem 216 may be manufactured from rod stock having a uniform diameter equal to the maximum outside diameter of the valve stem 216 such that only a minimal amount of turning or grinding, if any, needs to be performed to form the few regions of the valve stem 216 having a diameter smaller than the maximum outside diameter. A second benefit is that the tight, or near-tight, fit of the valve stem 216 within the central opening 208 can simplify the process of making the valve stem monolithic with the piston 204.

For example, with a relatively tight fit between the valve stem 216 and the piston 204, a number of welding techniques that do not use a filler material, such as energy beam (e.g., electron beam or laser) welding (indicated by energy beam 220) and friction (e.g., spin or stir) welding, among others, may be used. These welding techniques are well-known in the art and need not be explained in any detail for those skilled in the art to readily practice the present invention to its fullest scope as defined by the claims appended hereto. FIG. 2 illustrates a weld 224 resulting from energy beam welding performed from only one side of the piston 204. Of course, such welding may be performed from the other side of the piston 204, exclusively or in combination with welding from the side shown. After the weld 224 has been completed, the piston 204 and the valve stem 216 form a unified monolithic structure. Alternatives to energy beam welding for securing the valve stem 216 to the piston 204 include brazing and metal-to-metal adhesive bonding or press-fitting.

FIG. 3 illustrates an alternative unified monolithic piston/valve stem structure 300 of the present invention that includes a metal piston 304 having a stepped central opening 308 that extends only part of the way through the thickness of the piston 304. The central opening 308 includes a first portion 308A and a second portion 308B in which the first portion 308A has a smaller inside diameter than the inside diameter of the second portion 308B so as to form a seat 308C. Like the piston 204 of FIG. 2, the piston 304 may have a simple disk shape to simplify its manufacture. If desired, the piston 304 may include a generally circular scalloped region 312, or other region(s) of removed material, on one or both of its faces so as to reduce the mass of the unified monolithic piston/valve stem structure 300.

A stepped valve stem 316 includes a first portion 316A having an outside diameter selected so that this first portion 316A snugly engages the first portion 308A of the central opening 308 of the piston 304. The stepped valve stem 316 also includes a second portion 316B having an outside diameter that is larger than the outside diameter of the first portion 316A so as to form a shoulder 316C that engages seat 308C of the central opening 308 of the piston 304. However, the outside diameter of the second portion 316B may be smaller than inside diameter of second portion 308B of central opening 308 by an amount that facilitates at least partially filling the annular gap between the piston 304 and the valve stem 316 with a filler welding metal 320 from a suitable source, such as a consumable electrode 324.

The snug fit of the first portion 316A of the valve stem 316 with the first portion 308A of the central opening 308 allows the valve stem 316 to be supported by the piston 304 in its proper position for welding without the need for a jig or other apparatus to hold the valve stem 316 in position relative to the piston 304 during welding. While the connection between the valve stem 316 and the piston 304 are shown in this manner, those skilled in the art will readily appreciate that the shoulder 316C may be eliminated by making the outside diameter of the second portion 316B equal to the outside diameter of the first portion. In addition, or alternatively, the annular gap between the piston 304 and the valve stem 316 may be eliminated, and the joining of the piston 304 and valve stem 316 accomplished by another sort or filler metal welding, e.g., fillet welding, or non-filler metal welding, such as one of the welding methods discussed above in connection with the unified piston/valve structure 200 of FIG. 2.

FIG. 4 illustrates yet another unified monolithic piston/valve stem structure 400 that includes a metal valve stem 404 having a head 404A that is seated in similarly-sized countersink 408 in a corresponding metal piston 412 so that the “upper” (relative to FIG. 4) surface 404B of the head is substantially flush with the upper surface 412A of the piston 412 so as to facilitate stir welding of the joint 416 between the head and the piston 412 at these surfaces using a friction nib 420. The head 404A may be sized to provide a sufficient area for the stir welding to be performed and/or to develop the weld strength necessary to suite a particular design. The head 404A may be either formed integrally with the rest of the valve stem 404, e.g., molded, forged, and/or turned, or formed separately and secured to the rest of the valve stem 404, e.g., by welding. Those skilled in the art will readily understand how to size the head 404A according to the performance criteria of the unified monolithic piston/valve stem structure 400.

FIG. 5 illustrates a unified monolithic piston/valve stem structure 500 of the present invention having a valve stem 504 and a piston 508 that is molded to the valve stem 504, e.g., using a forming mold 512. Prior to molding the piston 508, a portion 504A of the valve stem 504 that will engage the molded piston 508 may be provided with surface features 504B that provide a mechanical interlock between the piston 508 and the valve stem 504 after the piston 508 has been molded about the valve stem 504 and has solidified. Those skilled in the art will readily understand how to select the appropriate materials for the piston 508 and the valve stem 504 for the successful molding of the piston onto the valve stem 504. The selection of materials may be based at least in part on the relative melting temperatures of the material(s).

For example, if the force transferred between the piston 504 and the valve stem 508 is to be purely or mostly through the mechanical interlock between the two components, then the melting point of the material of the piston 504 would need to be higher than the melting point of the material for the valve stem 508. On the other hand, if the force transfer is to rely more or solely on a fusion of the two parts with one another, the melting temperature of the material of the valve stem 504 may be closer to the melting point of the material for the piston 508. Alternatively, or additionally, additional heat could be added to the material of the piston 508 during molding to raise the temperature of the melt to a temperature that causes the material of the valve stem 504 to at least partially melt so that the parts are fused together upon cooling of the unified monolithic piston/valve stem structure 500 following molding. Those skilled in the art will readily understand the many variations on this molding scheme that are possible. After forming mold 512 is removed, the piston 508 may be machined and/or polished as necessary to suit a particular design. For example, an O-ring seat (not shown) may be machined into the outer periphery of the piston 508 and the piston 508 subsequently polished. Those skilled in the art will readily appreciate that the unified monolithic piston/valve stem structure 500 may be formed in a converse manner, if desired. That is, a preformed piston may first be provided and then a valve stem molded into the piston.

FIG. 6 is a unified monolithic piston/valve stem structure 600 of the present invention having a valve stem 604 and a piston 608 that are pre-formed separately from one another. The unification of the unified monolithic piston/valve stem structure 600 is accomplished by shrink fitting the piston 608 onto the valve stem 604 as indicated by arrows 612. In this example, the valve stem 604 has an outside diameter at a particular temperature T1. The shrink-fit unification may be accomplished by first providing the piston 608 with a central opening 616 having an inside diameter that is less than the outside diameter of the valve stem 604 at temperature T1. Then, the temperature of the piston 608 may be raised to a temperature greater than T1 so that the inside diameter of the central opening 616 increases and/or the temperature of the valve stem 604 may be lowered from T1 so that the outside diameter of the valve stem 604 decreases.

The temperature of one or both of the piston 608 and the valve stem 604 is/are continue to be changed until the temperature differential between the two parts allows the valve stem 604 to be inserted into the central opening 612. After the valve stem 604 has been inserted into the central opening 612, the two parts may be allowed, or forced, to come to that same temperature as one another. As the temperature of the piston 608 lowers and/or the temperature of the valve stem 604 rises, the piston 608 and the valve stem 604 press firmly against one another at their contacting surfaces so that the unitary monolithic piston/valve structure 600 develops a substantial pull-out resistance as between these two parts. If desired, the contacting surfaces of the piston 608 and the valve stem 604 may be roughened or otherwise treated to enhance the pull-out resistance of the monolithic piston/valve stem structure 600. Those skilled in the art will understand the variables, e.g., coefficients of thermal expansion, inside and outside diameters of the central opening 612 and the valve stem 604, respectively, temperature difference between the two parts, contacting-surface roughness, etc., at issue and will understand how to apply these variables to achieve a suitable pull out resistance without undue experimentation.

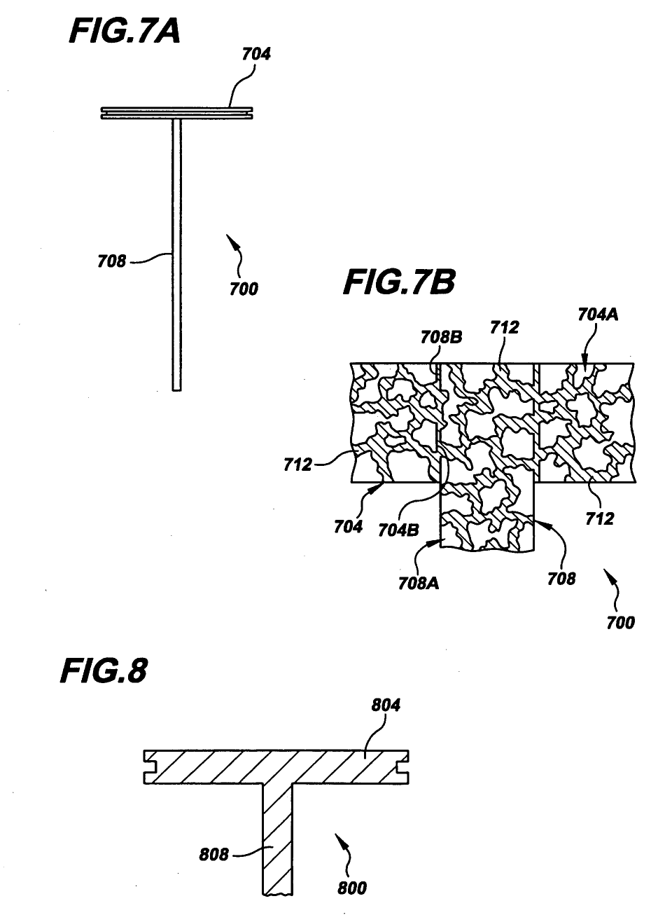

FIGS. 7A and 7B illustrate another embodiment of a unitary monolithic piston/valve stem structure 700 made in accordance with the present invention. In this embodiment, the unitary monolithic piston/valve stem structure 700 includes a piston 704 secured to a valve stem 708 via a metal infiltration technique. Generally, in the context of joining components, such as the piston 704 and valve stem 708, to each other, metal infiltration typically involves fashioning at least the portions of the components to be joined from a porous material, e.g., a sintered metal, placing the components immediately adjacent each other in their final positions relative to one another, and then filling by infiltration the voids of the porous material of the two components with a suitable infiltrant metal that has a melting point lower than the melting point of the porous material. Once the infiltrant metal solidifies, the combination becomes a solid composite of the originally porous material and infiltrant metal and the components become joined together with a joint that largely resembles a brazed joint.

FIG. 7B particularly illustrates the infiltration technique in the context of the unitary monolithic piston/valve stem structure 700. First, porous preforms 704A, 708A corresponding to, respectively, the piston 704 and valve stem 708 may be formed using any suitable technique, such as a sintering/debinderizing technique. In this technique, a parent metal, such as a tool grade steel, in powder form is mixed with a plastic binder and prepared for injection molding into piston and valve-stem molds (not shown). Those skilled in the art will appreciate that the metal powder loading in the metal powder/plastic mixture is sufficient that the just-molded, or green, parts will retain their shape when the parts are debinderized. The metal powder/plastic mixture is injection molded to produce a green piston and a green valve stem.

The green parts are then placed into a vacuum or inert gas environment where they are heated to a temperature below the melting point of the parent metal but above the melting point of the plastic binder so as to remove the binder from, i.e., debinderize, the parts so as to leave only skeletons of the metal powder in the shapes of the piston 704 and valve stem 708. The green piston and valve stem are then partially sintered to decrease the porosity of the parts, thereby yielding the sintered porous piston and valve stem preforms 704A, 708A of FIG. 7B. In order to maintain the interconnected porosity needed for infiltration, the sintering temperature should not exceed the temperature at which the pores begin to close. Generally, the piston and valve stem preforms 704A, 708A may have a porosity of around 10% to about 40% by volume.

Before or after sintering, the piston and valve stem preforms 704A, 708A may be placed and held in their final positions relative to one another. After sintering, an infiltrant metal 712 is infiltrated into the interconnected pores within the piston and valve stem preforms 704A, 708A and into any spaces between the two preforms 704A, 708A using a suitable technique. For example, the piston and valve stem preforms 704A, 708A may be placed into a vacuum or inert gas furnace in their proper relative positions and one or more masses (not shown) of infiltrant metal, e.g., in the form of ingots, sheets, beads, etc., may be placed into contact with the preforms 704A, 708A. The furnace is fired so as to heat the preforms 704A, 708A and infiltrant metal mass(es) to just above the melting point of the infiltrant metal. When the preforms 704A, 708A and infiltrant metal are at the infiltration temperature, the infiltrant metal mass(es) melt and the melt is absorbed into the preforms 704A, 708A and any spaces between the two preforms by capillary action of the interconnecting pores. With the infiltrant metal present at the confronting faces 704B, 708B of the piston and valve stem preforms 704A, 708A and the pore spaces present at these faces, the preforms 704A, 708A essentially become brazed together to create the unified monolithic piston/valve stem structure 700 shown more fully in FIG. 7A. In general, the infiltration temperature and time should be kept as low as possible to minimize any interaction or solubility between the parent metal and infiltrant metal.

While the foregoing examples of unitary monolithic piston/valve stem structures 200, 300, 400, 500, 600, 700 are assemblies of a corresponding piston component 204, 304, 412, 508, 608, 704 and a respective valve stem component 216, 316, 404, 504, 604, 708, FIG. 8 illustrates that a unified monolithic piston/valve stem structure 800 of the present invention may be made so that a piston portion 804 and a valve stem portion 808 are integral with each other, i.e., form a unitary, or single, mass of material. The unitary construction of the unified monolithic piston/valve stem structure 800 may be achieved in any of a number of ways.

For example, in the context of the infiltration technique described immediately above in connection with unified monolithic piston/valve stem structure 700 of FIGS. 7A-B, instead of forming the porous piston and valve stem preforms 704A, 708A separately and joining them by brazing during the infiltration process, a single preform (not shown) may be formed into the combined shape of the piston portion 804 (FIG. 8) and valve stem portion 808, e.g., using the injection molding and sintering techniques discussed above. Then, an infiltrant metal, such as described above, may be used to fill the voids of the preform so as to form a unitary composite mass consisting essentially of the sintered preform material and the infiltrant metal contained in the voids of the preform.

In other embodiments of the unified monolithic piston/valve stem structure 800, the unitary mass may be made using a rapid manufacturing technique, such as laser fusion (sintering) or electron beam fusion (sintering). Generally, these techniques involve selectively directing a relatively high energy beam, either a laser beam or electron beam, respectively, at a bed of small precursor particles, e.g., metal powder, so that the beam fuses the particles into a unitary mass that forms the unified monolithic piston/valve stem assembly 800. The beam selectively fuses the small particles by scanning cross-sections generated from a 3-D digital description of the unified monolithic piston/valve stem assembly 800 (e.g. from a CAD file or scan data) on the surface of a particulate bed. After each cross-section is scanned, the particulate bed is lowered by one layer thickness, a new layer of material is applied on top of the bed and the process is repeated until the unified monolithic piston/valve stem assembly 800 is completed. The process can achieve full melting, partial melting or liquid-phase sintering as desired for a particular application. Depending on the particulate material, up to 100% density can be achieved with material properties comparable to the properties obtained from conventional manufacturing methods.

Although the invention has been described and illustrated with respect to exemplary embodiments thereof, it should be understood by those skilled in the art that the foregoing and various other changes, omissions and additions may be made therein and thereto, without parting from the spirit and scope of the present invention.

What is claimed is:

1. A unified monolithic piston and valve stem structure for a hot runner that includes a gate shutoff area and nozzle assembly comprising an injection nozzle having a longitudinal central axis and an actuator cylinder spaced from the injection nozzle along the longitudinal central axis, the unified monolithic piston and valve stem structure comprising:
(a) a piston sized to operatively engage the actuator cylinder; and
(b) an elongate valve stem configured for controlling flow of a material through the gate shutoff area when the unified piston and valve stem structure is operatively engaged with the hot runner, said elongate valve stem including a piston-engaging end non-threadedly secured to said piston without any pre-formed securing devices.

2. A unified monolithic piston and valve stem structure according to claim 1, further comprising a weld formed between said valve stem and said piston, wherein said weld unifies said valve stem and said piston and does not include filler metal.

3. A unified monolithic piston and valve stem structure according to claim 1, further comprising a weld formed between said valve stem and said piston, wherein said weld unifies said valve stem and said piston and includes filler metal.

4. A unified monolithic piston and valve stem structure according to claim 1, further comprising an adhesive located between said valve stem and said piston so as to unify said valve stem and said piston.

5. A unified monolithic piston and valve stem structure according to claim 4, wherein said adhesive comprises a brazing metal.

6. A unified monolithic piston and valve stem structure according to claim 1, wherein said valve stem is unified monolithically with said piston by a shrink fit of said valve stem within said stem-receiving opening.

7. A unified monolithic piston and valve stem structure according to claim 1, wherein said valve stem is unified monolithically with said piston by molding one of said valve stem and said piston with the other of said valve stem and piston.

8. A unified monolithic piston and valve stem structure according to claim 1, wherein said valve stem comprises a porous valve stem preform and said piston comprises a porous piston preform, said porous valve stem preform being joined to said porous piston preform by an infiltrate material.

9. A unified monolithic piston and valve stem structure according to claim 1, wherein said piston and said valve stem form a single mass of material.

10. A unified monolithic piston and valve stem structure according to claim 9, wherein said piston and said valve stem together comprise a porous unitary piston and valve stem preform having void substantially filled with an infiltrate material.

11. An assembly for a hot runner, comprising:
(a) an injection nozzle having a longitudinal central axis;
(b) an actuator cylinder spaced from said injection nozzle along said longitudinal central axis;
(c) a unified monolithic piston and valve stem structure comprising:
(i) a piston operatively engaging the actuator cylinder; and
(ii) an elongate valve stem configured for controlling flow of a material through said injection nozzle and including a piston-engaging end non-threadedly secured to said piston without any preformed securing devices.

12. An assembly according to claim 11, further comprising a weld formed between said valve stem and said piston, wherein said weld unifies said valve stem and said piston and does not include filler metal.

13. An assembly according to claim 11, further comprising a weld formed between said valve stem and said piston, wherein said weld unifies said valve stem and said piston and includes filler metal.

14. An assembly according to claim 11, further comprising an adhesive located between said valve stem and said piston so as to unify said valve stem and said piston.

15. An assembly according to claim 14, wherein said adhesive comprises a brazing metal.

16. An assembly according to claim 11, wherein said valve stem is unified monolithically with said piston by a shrink fit of said valve stem within said opening.

17. An assembly according to claim 11, wherein said valve stem is unified monolithically with said piston by molding one of said valve stem and said piston with the other of said valve stem and piston.

18. An assembly according to claim 11, wherein said valve stem comprises a porous valve stem preform and said piston comprises a porous piston preform, said porous valve stem preform being joined to said porous piston preform by an infiltrate material.

19. An assembly according to claim 11, wherein said piston and said valve stem form a single mass of material.

20. An assembly according to claim 19, wherein said piston and said valve stem together comprise a porous unitary piston and valve stem preform having void substantially filled with an infiltrate material.

21. A hot runner for injection molding plastic parts, comprising:
(a) a manifold plate;
(b) at least one drop extending through said manifold plate, said at least one drop comprising:
(i) an injection nozzle having a longitudinal central axis;
(ii) an actuator cylinder spaced from said injection nozzle along said longitudinal central axis;
(iii) a unified monolithic piston and valve stem structure comprising:
(A) a piston operatively engaging the actuator cylinder; and
(B) an elongate valve stem configured for controlling flow of a material through said injection nozzle and including a piston-engaging end non-threadedly secured to said piston without any preformed securing devices.

22. A hot runner according to claim 21, further comprising a weld formed between said valve stem and said piston, wherein said weld unifies said valve stem and said piston and does not include filler metal.

23. A hot runner according to claim 21, further comprising a weld formed between said valve stem and said piston, wherein said weld unifies said valve stem and said piston and includes filler metal.

24. A hot runner according to claim 21, further comprising an adhesive located between said valve stem and said piston so as to unify said valve stem and said piston.

25. A hot runner according to claim 24, wherein said adhesive comprises a brazing metal.

26. A hot runner according to claim 21, wherein said valve stem is unified monolithically with said piston by a shrink fit of said valve stem within said opening.

27. A hot runner according to claim 21, wherein said valve stem is unified monolithically with said piston by molding one of said valve stem and said piston with the other of said valve stem and piston.

28. A hot runner according to claim 21, wherein said valve stem comprises a porous valve stem preform and said piston comprises a porous piston preform, said porous valve stem preform being joined to said porous piston preform by an infiltrate material.

29. A hot runner according to claim 21, wherein said piston and said valve stem form a single mass of material.

30. A hot runner according to claim 29, wherein said piston and said valve stem together comprise a porous unitary piston and valve stem preform having void substantially filled with an infiltrate material.

31. A method of making a unified monolithic piston and valve stem structure for a hot runner comprising a drop that includes a valve actuator cylinder having an inside diameter, the method comprising:
(a) providing a valve stem having a configuration selected to control flow of a material from the drop;
(b) providing a piston having an outside diameter selected as a function of the inside diameter of the valve actuator cylinder; and
(c) non-threadedly unifying said valve stem and said piston with one another without using any preformed securing devices.

32. A method according to claim 31, wherein step (c) includes welding said valve stem and said piston with one another.

33. A method according to claim 31, wherein the step of welding said valve stem and said piston with one another includes non-filler welding said valve stem and said piston with one another.

34. A method according to claim 31, wherein step (c) includes bonding said valve stem and said piston with one another.

35. A method according to claim 34, wherein step (c) includes brazing said valve stem and said piston with one another.

36. A method according to claim 31, wherein step (c) includes shrink fitting said valve stem and said piston with one another.

37. A method according to claim 31, wherein step (c) includes molding one of said valve stem and said piston with the other of said valve stem and said piston.

38. A method according to claim 31, wherein step (a) includes providing a porous valve stem preform, step (b) includes providing a porous piston preform, and step (c) includes infiltrating an infiltrant material into each of said porous valve stem preform and said porous piston preform.

39. A method according to claim 31, wherein step (c) comprises forming a single mass of material that includes both said valve stem and said piston.

40. A method according to claim 39, wherein the step of forming said single mass of material includes molding a unitary porous preform that includes a piston portion and a valve stem portion.

41. A method according to claim 40, wherein the step of forming said single mass of material further includes substantially filling said unitary porous preform with an infiltrant material.

42. A method according to claim 39, wherein the step of forming said single mass of material using a rapid manufacturing technique.
